(19) United States
(12) Patent Application Publication
(10) Pub. No.: US 2021/0252526 A1
(43) Pub. Date: Aug. 19, 2021

(54) TEMPERATURE-CONTROLLED CENTRIFUGE WITH CRASH PROTECTION

(71) Applicant: Eppendorf AG, Hamburg (DE)

(72) Inventors: Heiko MÜLLER, Borsdorf (DE); Andreas KEIL, Audenhain (DE)

(73) Assignee: Eppendorf AG, Hamburg (DE)

(21) Appl. No.: 17/251,826

(22) PCT Filed: Jun. 13, 2019
(86) PCT No.: PCT/EP2019/065614

§ 371 Date: Dec. 14, 2020

(30) Foreign Application Priority Data
Jun. 15, 2018 (DE) 10 2018 114 450.4

(51) Int. Cl. B04B 7/06; B04B 15/02; F25B 39/02

(52) U.S. Cl. CPC B04B 7/06; F25B 2600/21; F25B 39/02; B04B 15/02

(57) ABSTRACT

A centrifuge and a method for preventing ignition of combustible temperature-control media in centrifuges after a crash of the centrifuge rotor are presented. It is monitored whether the pressure in the evaporator lies below a specified minimum pressure and/or above a specified maximum pressure. Measures to prevent ignition of the temperature-control medium can be taken in a targeted manner. In the event that the pressure lies below a minimum pressure, it must be assumed that either a leak or a crash is present, wherein a leak leads to a slow release of combustible temperature-control medium and a crash leads to an sudden release of combustible temperature-control medium. If the pressure lies above a maximum pressure, there is a risk that there is a large amount of combustible temperature-control medium in the evaporator which could be ignited in the event of a crash.

### TECHNICAL FIELD

The present disclosure relates to a centrifuge and to a method for preventing ignition of combustible temperature-control media in centrifuges.

### BACKGROUND

Centrifuge rotors are used in centrifuges, in particular laboratory centrifuges, to separate the components of samples centrifuged in them by utilizing mass inertia. In doing so, increasingly higher rotation speeds are used to achieve high segregation rates. Laboratory centrifuges are centrifuges whose rotors operate at preferably at least 3,000, preferentially at least 10,000, in particular at least 15,000 revolutions per minute, and are usually placed on tables. In order to be able to place them on a work table, they have a form factor of less than 1 m×1 m×1 m, so their installation space is limited. Preferably, the device depth is thereby limited to a maximum of 70 cm.

Such centrifuges are used in the fields of medicine, pharmacy, biology and chemistry, etc.

The samples to be centrifuged are stored in sample containers and such sample containers are driven in rotation by a centrifuge rotor. In doing so, the centrifuge rotors are typically set in rotation by means of a vertical drive shaft driven by an electric motor. There are different centrifuge rotors that are used depending on the purpose of the application. The sample containers can contain the samples directly or the sample containers have their own sample receptacles that contain the sample, such that a large number of samples can be centrifuged simultaneously in a sample container. Generally, centrifuge rotors are known in the form of fixed-angle rotors and swing-out rotors and others.

It is usually provided that the samples are centrifuged at certain temperatures. For example, samples containing proteins and similar organic substances must not be overheated, and therefore the upper limit for the temperature control of such samples is normally in the area of +40° C. On the other hand, certain samples are cooled as standard in the area of +4° C. (the anomaly of the water starts at 3.98° C.).

In addition to such predetermined maximum temperatures of, for example, approximately +40° C. and standard examination temperatures of, for example, +4° C., further standard examination temperatures are also provided for, for example, at +11° C., in order to check, at such temperature, whether the refrigeration system of the centrifuge is running in a controlled manner below room temperature. On the other hand, it is necessary for reasons of occupational safety to prevent the touching of elements that have a temperature greater than or equal to +60° C.

In principle, active and passive systems can be used for temperature control. Passive systems are based on air-assisted ventilation. Such air is led directly past the centrifuge rotor, which results in temperature control. The air is sucked through openings into the centrifuge vessel and through further openings the heated air is discharged again at another point of the centrifuge vessel, wherein the suction and discharge takes place independently through the rotation of the centrifuge rotor.

Active cooling systems, on the other hand, have a refrigerant circuit that controls the temperature of the centrifuge container, by which the centrifuge rotor and the sample containers incorporate therein is indirectly cooled. Many different media are used as cooling or temperature-control media in compressor-operated refrigeration systems. Since, in principle, not only cooling (that is, heat extraction), but also heat supply can be desired in a targeted manner during centrifugation, the present invention refers to temperature control and temperature-control media. In addition to the temperature-control media usually used for centrifuges, such as chlorodifluoromethane, tetrafluoroethane, pentafluoroethane or difluoromethane and many others, there are also combustible temperature-control means, such as butane or propane, or various synthetic mixtures.

Although such combustible temperature-control media have very good heat transfer properties, they are usually not used for safety reasons, since the temperature control means can escape and ignite in the event of a crash of the centrifuge rotor. In the event of such a crash, fragments of the centrifuge rotor can act at high speed and thus with very high energy within the centrifuge, thereby also destroying the evaporator and lines carrying the temperature-control medium. The escaping combustible temperature-control medium can then be easily ignited by the energy released in the crash and by electrical or electronic components inside the centrifuge or in its vicinity, which can cause very serious damages, in particular personal injuries.

In order to prevent a crash of the centrifuge rotor from causing damages outside the centrifuge, means of stiffening and reinforcing inside the centrifuge have already been proposed. However, this would not prevent temperature-control media from escaping, because the lines of temperature control means, which form the evaporator, run around the centrifuge container between the centrifuge rotor and the reinforcing means.

### SUMMARY

As such, it is the task of the present disclosure to propose a centrifuge that can be used in combination with combustible temperature-control media, without these constituting an increased safety risk in the event of a crash of the centrifuge rotor.

This task is achieved with the centrifuge and the method as claimed.

It was recognized on the part of the inventor that such task can be achieved in a surprisingly simple way by monitoring the pressure in the evaporator to see whether it lies below a specified minimum value or above a specified maximum value. Measures to prevent a possible ignition of the temperature-control medium can be taken in a targeted manner. In the event that the pressure lies below a minimum pressure, it must be assumed that either a leak or a crash is present, wherein a leak in the evaporator is very unlikely, but nevertheless leads to a slow release of combustible temperature-control medium and a crash leads to a sudden release of combustible temperature-control medium. If the pressure lies above a maximum pressure, there is a risk that there is a large amount of combustible temperature-control medium in the evaporator that could escape and be ignited in the event of a crash.

The method for preventing ignition of combustible temperature-control media in centrifuges, in particular after a crash of the centrifuge rotor, wherein the centrifuge, which is designed in particular as a laboratory centrifuge, comprises a centrifuge container in which a centrifuge rotor can be accommodated, a centrifuge motor for driving the centrifuge rotor, temperature control means with an evaporator and a compressor for controlling the temperature of the centrifuge rotor and a housing, in which the centrifuge container, the centrifuge rotor, the temperature control means and the centrifuge motor are accommodated, wherein the temperature control means comprises a combustible temperature-control medium, which is guided in a temperature-control medium line, is characterized in that the pressure in the evaporator is monitored to determine whether it lies below a specified minimum pressure and/or above a specified maximum pressure.

In an advantageous additional form, it is provided that the pressure is determined at the outlet of the evaporator, wherein a pressure sensor, in particular in the form of a pressure transmitter, is preferentially used. This makes it particularly easy to monitor the pressure and take direct control measures.

In an advantageous additional form, it is provided that the specified minimum pressure is at least 0.7 bar, preferentially at least 1 bar and in particular at least 1.3 bar.

In an advantageous additional form, it is provided that the specified maximum pressure is at most 5 bar, preferentially at most 3 bar, in particular at most 2 bar.

In an advantageous additional form, the temperature-control medium R290 propane is used. Alternatively, isobutane, propene, butene, etc. can be used. However, R290 propane is preferentially used on the basis of its advantageous parameters (pressure ranges, temperature curves, boiling point, enthalpies and volumetric degree of efficiency).

Ultimately, the pressure range is directly dependent on the temperature-control medium used and the intended use (for example, deep-freezing or normal refrigeration); it has been shown with R290 propane that the aforementioned pressure range is advantageous.

In an advantageous additional form, it is provided that one or more of the following measures are carried out if the evaporator pressure is below the specified minimum pressure:
the supply of temperature-control medium to the evaporator is interrupted;
the compressor is switched off;
the electrical power supply to the electrical elements of the centrifuge, which could cause an explosion and which are not explosion-proof or designed to consume less than 20 W electrical power, is stopped;
the centrifuge motor is stopped;
residual electrical energy is directed in a targeted manner to a fan of the centrifuge for its operation.

If the supply of temperature-control medium to the evaporator is interrupted, only the temperature-control medium already in the evaporator can be ignited, which effectively limits the ignitable quantity.

If the compressor is switched off, no air is sucked into the remaining circuit with the temperature-control medium, by which safety is improved.

If the electrical power supply is stopped, the centrifuge itself cannot cause ignition. Explosion-proof components are those according to the ATEX Directive of the European Union (ATEX Product Directive 2014/34/EU and the ATEX Operating Directive 1999/92/EC), or elements with a power consumption of less than 20 W.

The centrifuge motor is preferentially designed to be explosion-proof, in order to prevent ignition by the centrifuge motor.

In an advantageous additional form, it is provided that the temperature-control medium circuit contains a quantity of temperature-control medium of less than 150 g, preferentially less than 140 g, particularly preferentially less than 130 g, in particular less than 120 g.

In an advantageous additional form, it is provided that the temperature-control medium circuit contains a quantity of temperature-control medium of more than 30 g, preferentially of more than 40 g, particularly preferentially of more than 50 g. Advantageously, the quantity lies in the range of 60 g to 110 g, but the other specified quantities can also be used for this range.

If the centrifuge motor is stopped, a crash that has not yet taken place is prevented, or a crash that has already taken place is mitigated in its extent. Advantageously, the switching off of the centrifuge motor takes place if the centrifuge motor is designed to be explosion-proof, because this provides mechanical crash protection.

If the residual electrical energy is fed to a fan of the centrifuge, the temperature-control medium is so dispersed that ignition is made difficult. Such an electrical fall-back level could be realized, for example, by means of at least one relay which is constantly energized during normal operation. In the event of a crash, if there is no current to energize or a deliberate changeover is made, the relay then makes contact between the residual electrical energy (for example, from capacitors and the like) and the fan. Such capacitors could be standard capacitors in the electronic system of the laboratory centrifuge. Special capacitors or accumulators, which only exist to be charged during normal operation and to supply energy to the fan on request, could also be used. For example, in the event of a crash, the request could be made by the aforementioned relay or the like.

In an advantageous additional form, it is provided that, at an evaporator pressure above the specified maximum pressure, the quantity of temperature-control medium in the evaporator is reduced. This ensures that, for a possible crash, the ignitable quantity is kept as low as possible from the outset.

In an advantageous additional form, it is provided that one or more of the following measures be carried out if the evaporator pressure is above the specified maximum pressure:
the supply of temperature-control medium to the evaporator is interrupted;
the capacity of the compressor is increased;
the temperature-control medium is fed into a temperature-control medium storage tank.

If the supply of temperature-control medium to the evaporator is interrupted, the ignitable quantity is kept as low as possible.

If the capacity of the compressor is increased, temperature-control medium is sucked out of the evaporator, such that the ignitable quantity is kept as low as possible.

If temperature-control medium is fed into a temperature-control medium storage tank, the quantity of ignitable temperature-control medium in the evaporator is also reduced. This can take place, for example, by closing a valve in the temperature-control medium circuit. such that no temperature-control medium can flow into the evaporator. This causes the compressor to pump the temperature-control medium down to the minimum pressure and automatically feeds it into the open temperature-control storage tank. The temperature-control medium is taken again from the temperature-control medium storage tank simply by opening the valve in the line. In normal operation, the valve remains open.

Before increasing the capacity of the compressor or introducing the temperature-control medium into the temperature-control medium storage tank, the supply of temperature-control medium to the evaporator is therefore preferentially interrupted.

In an advantageous additional form, it is provided that a fan of the centrifuge is started after switching on an electrical power supply of the centrifuge. Thereby, any possible escaping temperature-control medium is dispersed from the outset in such a manner that possible ignition is prevented. This method is independent of whether or not the pressure in the evaporator is monitored.

This or the aforementioned fan, which serves to disperse a possible escaping temperature-control medium, can be a fan specially configured for this purpose, but it can also be a fan for cooling the electronic system of the centrifuge or a fan for operating the condenser of the centrifuge. Preferentially, the fan should be set up in such a manner that its flow is directed over the temperature-control medium line at least in some areas and/or through at least one, in particular several cavities in the centrifuge in such a manner that the resulting exhaust air is conveyed out of the housing of the centrifuge. These preferably comprise cavities that can fill up with escaped temperature-control medium.

In an advantageous additional form, it is provided that the fan is operated in such a manner that no explosion-critical temperature-control medium-air mixture is produced, preferentially no temperature-control medium-air mixture with a temperature-control medium content of 2 to 9 vol. % is produced.

The centrifuge, in particular a laboratory centrifuge, may include a centrifuge container in which a centrifuge rotor can be accommodated, a centrifuge motor for driving the centrifuge rotor, temperature control means with an evaporator and a compressor for controlling the temperature of the centrifuge rotor and a housing, in which the centrifuge container, the centrifuge rotor, the temperature control means and the centrifuge motor are accommodated, wherein the temperature control means comprises a combustible temperature-control medium which is guided in a temperature-control medium line, which is characterized in that the centrifuge is adapted to determine whether the pressure in the evaporator lies below a specified minimum pressure and/or above a specified maximum pressure.

In an advantageous additional form, it is provided that the centrifuge is adapted to carry out the method in accordance with the disclosure.

In an advantageous additional form, it is provided that at least one of the elements of the electrical supply line to a non-explosion-proof component, switch in electrical supply line to a non-explosion-proof component and control unit of the centrifuge are arranged in the crash area of the centrifuge. Then, in the event of a crash, the power supply to the non-explosion-proof components is deliberately interrupted, thus preventing ignition. “Crash area” in this context means the area around the centrifuge container. If a crash protection device in the form of one or more stiffening elements or crash energy absorber elements is present in the centrifuge, then such elements should be arranged between the centrifuge container and the stiffening elements or crash energy absorber elements. This design of the centrifuge is independent of whether or not a sensor for monitoring the pressure in the evaporator is present.

In an advantageous additional form, it is provided that a solenoid valve is arranged in front of the inlet of the evaporator, wherein the solenoid valve is preferentially arranged in front of the pressure relief element. A solenoid valve, which is always kept open by the electrical supply to the centrifuge, automatically closes due to spring force when the electrical supply is interrupted, as is to be expected in the event of a crash. For safety reasons, the pressure monitoring system can automatically close the solenoid valve if the pressure falls below the minimum pressure. In the event of a crash, this prevents the temperature-control medium from flowing in after the crash and possibly being ignited. Electronic injection valves-NC (normally closed) or pressure switching valves can also be used as an alternative to a solenoid valve.

In an advantageous additional form, it is provided that a non-return valve is arranged after the outlet of the evaporator. This prevents temperature-control medium from flowing back from the condenser via the compressor, which leaks over time, into the evaporator in the event of a crash. As an alternative to a non-return valve, an additional solenoid valve could also be used.

In an advantageous additional form, it is provided that at least one of the elements of centrifuge motor, main electrical switch, fan, pressure monitoring control and pressure monitoring sensor are designed to be explosion-proof and/or to consume less than 20 W of electrical power. This allows such elements to be operated on a lasting basis and to carry out monitoring or ignition protection measures without contributing to ignition.

In an advantageous additional form, it is provided that the centrifuge has a gas sensor outside the temperature control means, whereby, independently of a pressure drop, leaks can be detected below the minimum pressure, in order to prevent the centrifuge from starting.

In an advantageous additional form, it is provided that the centrifuge is designed to supply a fan with residual electrical energy present in the centrifuge after the failure of the electrical power supply, wherein a relay is preferentially provided, which is fed by the electrical power supply and, in the event of the failure of the electrical power supply, connects at least one element with residual electrical energy to the fan, wherein the at least one element is in particular a capacitor. This ensures that, even in the event of a crash, and if the electrical power supply fails, the temperature control means is dispersed as long as possible.

The features and further advantages of the present invention will be made clear in the following on the basis of a description a preferential exemplary embodiment in connection with the figures.

### BRIEF DESCRIPTION OF THE DRAWINGS

FIG. 1a shows a centrifuge in a perspective view.

FIG. 1b shows the centrifuge according to FIG. 1a in a sectional view.

FIG. 2 shows the centrifuge according to FIG. 1a in a simplified block diagram with regard to the temperature control means.

FIG. 3 shows the centrifuge according to FIG. 1a in a block diagram with regard to a highly simplified circuit diagram.

### DETAILED DESCRIPTION

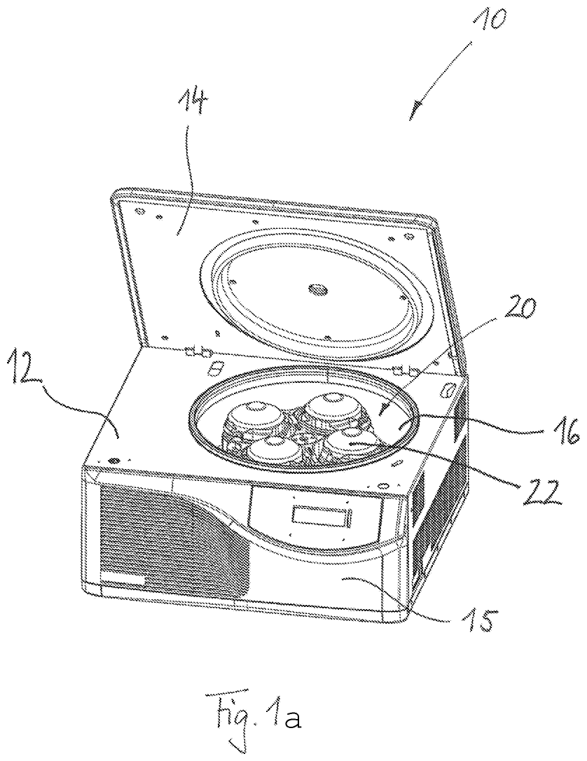

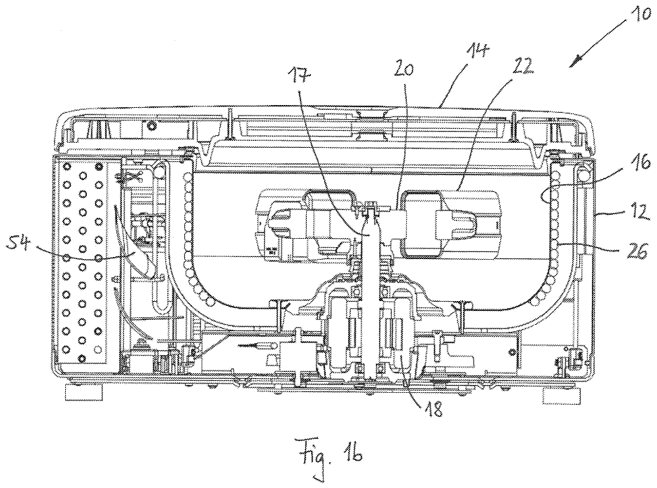

In FIGS. 1a to 3, the centrifuge 10 is shown purely schematically in various views.

The centrifuge 10 is designed as a laboratory centrifuge with a housing 12 with a lid 14 and an operating front 15. In the centrifuge container 16 of the centrifuge 10, a centrifuge rotor 20 is arranged on a drive shaft 17 of a centrifuge motor 18, which is designed as a swing-out rotor with centrifuge beakers 22.

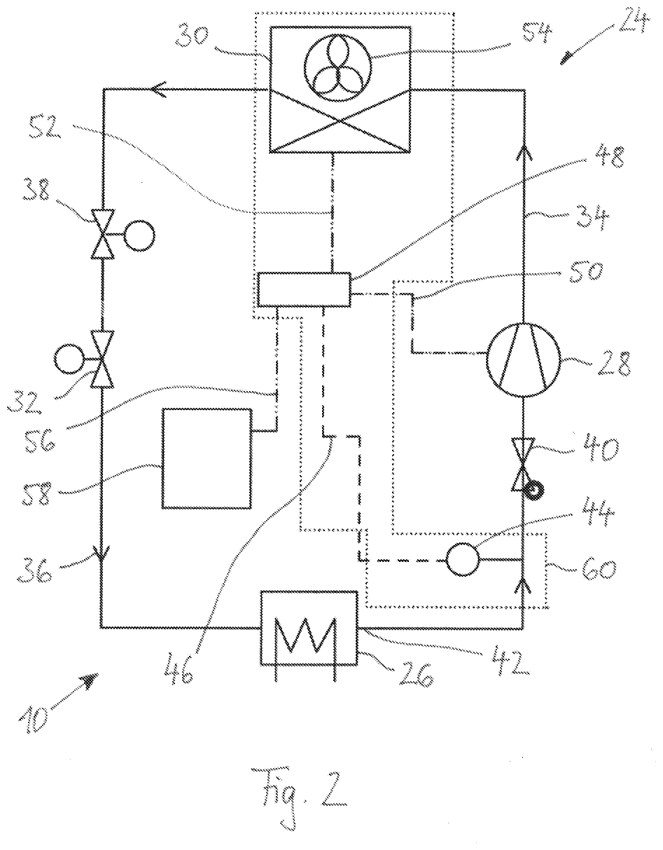

FIG. 2 shows that the centrifuge has temperature-control means 24, comprising an evaporator 26, a compressor 28, a condenser 30 and a thermostatic injection valve 32, which are connected by a temperature-control media line 34.

The evaporator 26, for example, is designed as a temperature-control media line section that extends around the centrifuge vessel 16.

A solenoid valve 38 is arranged between the condenser 30 and the evaporator 26 in the temperature-control medium line 34 in the direction of flow 36 in front of the injection valve 32.

Between the evaporator 26 and the compressor 28, a non-return valve 40 blocking against the direction of flow 36 is arranged in the temperature-control medium line 34.

A pressure sensor 44 in the form of a pressure transmitter is arranged at the outlet 42 of the evaporator 26, the signal 46 of which feeds a monitoring and control device 48. The monitoring and control device 48 preferentially has a processor (not shown) and controls by means of a control line 50 the compressor 28, by means of a control line 52 a fan 54, which is assigned to the condenser 30, and by means of a control line 56 the group 58 of the actual control unit including the electrical and electronic components and the centrifuge motor 18 of the centrifuge 10.

The group 60 of the components of pressure sensor 44, monitoring and control device 48 and fan 54 is designed to be explosion-proof and/or to consume less than 20 W electrical power, that is, such components cannot under any circumstances ignite the temperature-control medium in the temperature control means 24. R290 propane is preferentially used as the temperature-control medium.

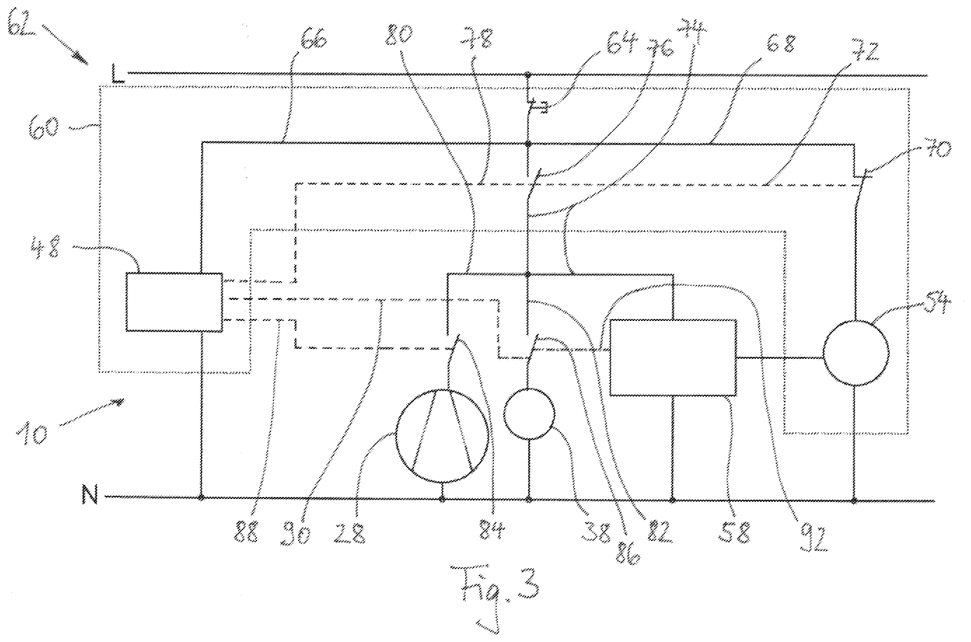

FIG. 3 shows that the electrical power supply 62 of the centrifuge 10 has a conducting phase L and a neutral conductor N and is started by a main switch 64.

The main switch 64 connects the monitoring and control device 48 directly via line 66 to the electrical power supply 62.

There is also a line 68, which can be disconnected by a switch 70, which connects the fan 54 with the electrical power supply 62. The switch 70 is switched by the monitoring and control device 48 via the connection 72, in such a manner that, after the centrifuge has been started via the main switch 64, the fan 54 starts automatically at a low speed.

There is also a line 74, which can be disconnected via a switch 76, which connects the group 58 of the actual control unit including the electrical and electronic components and the centrifuge motor 18 of the centrifuge 10 with the electrical power supply 62. Such switch 76 can likewise be switched by the monitoring and control device 48 via the connection 78.

Following the line 74, there are lines 80, 82, which connect the compressor 28 and the solenoid valve 38 with the electrical power supply 62. Such lines also have switches 84, 86, which can also be switched by the monitoring and control device 48 via the connections 88 and 90.

The switch 86 for the solenoid valve 38 is also supplied with electrical energy 92 by the control unit 58 of the centrifuge 10, wherein it is closed if such electrical energy 92 is applied to the control unit 58.

It can be seen that the group 60 of the components designed to be explosion-proof and/or to consume less than 20 W electrical power not only includes pressure sensor 44, monitoring and control device 48 and fan 54, but also the main switch 64, switch 70 in line 68 and switch 76 in line 74.

The centrifuge 10 now functions as follows with regard to ignition protection:

As soon as the main switch 64 is actuated, the monitoring and control device 48 is activated, which on its part closes the switch 70, such that the fan 54 of the condenser 30 is supplied in such a manner that it operates at a low speed, preferentially at least 200 rpm. Even if temperature-control medium has already leaked out due to a leak, it will be dispersed such that the formation of an ignitable mixture is prevented.

If the monitoring and control device 48 detects via the pressure sensor 44 that the pressure in the evaporator 26 is above a minimum pressure of 1.3 bar, the switch 76 is closed, such that the group 58 of the actual control unit including the electrical and electronic components and the centrifuge motor 18 of the centrifuge 10 is supplied with electrical energy. Furthermore, the switches 84 and 86 are closed, such that both the compressor 28 is operated and the solenoid valve 38 is closed. The compressor can now be operated by the control unit 58 according to requirements.

If the pressure sensor 44 detects a pressure in the evaporator 26 that is greater than the specified maximum pressure of 2 bar, there is a risk that there is too much combustible temperature-control medium in the event of a crash. The monitoring and control device 48 will then open the switch 86, by which the solenoid valve 38 interrupts the supply of temperature-control medium to the evaporator 26. Furthermore, the monitoring and control device 48 will increase the capacity of compressor 28 (the corresponding direct control of compressor 28 by the monitoring and control device 48 is not shown). In addition, it may be provided that temperature-control medium is routed into a temperature-control medium storage tank (not shown). For this purpose, a valve (not shown) arranged between the storage tank and the temperature-control medium line 34 is opened. This reduces the amount of temperature-control medium in the evaporator 26 such that the pressure in the evaporator 26 returns to between minimum pressure and maximum pressure. Subsequently, the switch 86 is closed again by the monitoring and control device 48 in order to open solenoid valve 38 again, the compressor control unit is taken over again by the control unit 58 and the temperature-control medium is removed from the storage tank again if necessary.

If the pressure sensor 44 detects a pressure in the evaporator 26 that is lower than the specified minimum pressure of 1.3 bar, there is a risk of a crash in which temperature-control medium could be ignited. In order to prevent this, the monitoring and control device 48 opens the switch 86, which causes the solenoid valve 38 to interrupt the supply of the temperature-control medium to the evaporator 26. In addition, the monitoring and control device 48 will open the switch 76, which will shut down all non-explosion-proof components of the centrifuge 10, such as the compressor 28 and the control unit 58, making ignition impossible. The switch 70 is left open in a targeted manner and residual electrical energy from capacitors in particular is transferred to the fan 54 in order to operate it to disperse the temperature-control medium. Such an electrical fall-back level could be realized, for example, by means of at least one relay (not shown), which is constantly energized during normal operation. Such relay is switched over in a targeted manner by the monitoring and control device 48, such that contact is established between the residual electrical energy (for example, from capacitors and the like) and the fan 54.

Only after opening the main switch 64 can the centrifuge 10 be restarted if the monitoring and control device 48 determines that the pressure in the evaporator 28 is at least as high as the minimum pressure of 1.3 bar.

In the event of a crash itself, the control unit 58 and the lines 74, 82 are destroyed, such that all non-explosion-proof components, in particular the compressor 28, the control unit 58 and the centrifuge motor 18, are no longer supplied with energy and at the same time the solenoid valve 38 is closed, by which ignition is prevented. The lines 74, 82 and in particular also the switches 76, 86 and the control unit 58 are arranged for this purpose in the crash zone, that is, preferentially between the centrifuge container 16 and a crash protection device, if present, in the form of one or more stiffening elements or crash energy absorber elements.

It is clear from the preceding description that the present invention provides a centrifuge 10 with which combustible temperature-control media can also be used without safety concerns within the framework of a temperature control without posing a safety risk in the event of a crash of the centrifuge rotor.

Unless otherwise indicated, all features of the present disclosure may be freely combined. Moreover, the features described in the description of figures may, unless otherwise indicated, be freely combined with the other features. Thereby, substantive features of the centrifuge can also be used within the framework of a method reformulated as method features and method features within the framework of the centrifuge reformulated as features of the centrifuge.

### LIST OF REFERENCE SIGNS

10 Centrifuge, laboratory centrifuge
12 Housing
14 Lid
15 Operating front
16 Centrifuge container
17 Drive shaft
18 Centrifuge motor
20 Centrifuge rotor, swing-out rotor
22 Centrifuge beaker
24 Temperature control means
26 Evaporator
28 Compressor
30 Condenser
32 Thermostatic injection valve
34 Temperature-control medium line
36 Direction of flow
38 Solenoid valve
40 Non-return valve
42 Outlet of evaporator 26
44 Pressure sensor, pressure transmitter
46 Signal of the pressure sensor 44
48 Monitoring and control device
50 Control line of monitoring and control device 48 to compressor 28
52 Control line of monitoring and control device 48 to fan 54
54 Fan
56 Control line of monitoring and control device 48 to group 58
58 Group of the actual control unit including the electrical and electronic components and the centrifuge motor 18 of the centrifuge 10
60 Group of explosion-proof components, such as pressure sensor 44, monitoring and control device 48 and fan 54
62 Electrical power supply of the centrifuge 10
64 Main switch of electrical power supply 62
66 Line
68 Line
70 Switch in line 68
72 Connection, control unit of switch 70 by the monitoring and control device 48
74 Line, electrical supply line
76 Switch in line 74
78 Connection, control unit of switch 76 by the monitoring and control device 48
80, 82 Lines, electrical supply lines
84, 86 Switches in the lines 80, 82
88, 90 Connections, control units of switches 84, 86 by the monitoring and control device 48
92 Supply of the switch 86 with electrical energy through the control unit 58
L Conducting phase of the electrical power supply 62
N Neutral conductor N of the electrical power supply 62

1.-13. (canceled)

14. A method for preventing ignition of combustible temperature-control media in centrifuges, comprising:
providing a centrifuge (10) which comprises
a centrifuge container (16) in which a centrifuge rotor (20) can be accommodated,
a centrifuge motor (18) for driving the centrifuge rotor (20),
a temperature control (24) with
an evaporator (26),
a compressor (28), and
a combustible temperature-control medium which is guided in a temperature-control medium line (34)
for the temperature control of the centrifuge rotor (20), and
a housing (12), in which the centrifuge container (16), the centrifuge rotor (20), the temperature control (24) and the centrifuge motor (18) are accommodated;
monitoring a pressure in the evaporator (26); and
determining whether the pressure in the evaporator (26) lies below a specified minimum pressure or above a specified maximum pressure.

15. The method according to claim 14,
wherein monitoring the pressure in the evaporator (26) is performed by a pressure sensor arranged at an outlet (42) of the evaporator (26).

16. The method according to claim 14,
wherein the specified minimum pressure is at least 0.7 bar and/or
wherein the specified maximum pressure is at most 5 bar.

17. The method according to claim 14, further comprising performing one or more of the following actions upon determining that the pressure in the evaporator (26) lies below a specified minimum pressure:
a) interrupting a supply of temperature-control medium to the evaporator (26);
b) switching off the compressor (28);
c) stopping an electrical power supply (62) of electrical elements (58) of the centrifuge (10) which could cause an explosion and are not explosion-proof nor designed to absorb less than 20 W electrical power;
d) switching off the centrifuge motor (18); and
e) directing residual electrical energy in a targeted manner to a fan (54) for its operation.

18. The method according to claim 14, further comprising reducing an amount of temperature-control medium in the evaporator (26) upon determining that the pressure in the evaporator (26) lies above the specified maximum pressure.

19. The method as in claim 18, further comprising one or more of the following steps:
f) interrupting a supply of temperature-control medium to the evaporator (26);
g) increasing a capacity of the compressor (28); and
h) feeding the temperature-control medium into a temperature-control medium storage tank.

20. The method according to claim 14, further comprising starting a fan (54) of the centrifuge after switching on an electrical power supply (62) of the centrifuge (10).

21. A centrifuge (10), comprising:
a centrifuge container (16) in which a centrifuge rotor (20) can be accommodated;
a centrifuge motor (18) for driving the centrifuge rotor (20);
temperature control (24) with
an evaporator (26),
a compressor (28), and
a combustible temperature-control medium which is guided in a temperature-control medium line (34)
for the temperature control of the centrifuge rotor (20); and
a housing (12) in which the centrifuge container (16), the centrifuge rotor (20), the temperature control (24) and the centrifuge motor (18) are accommodated,
wherein the centrifuge (10) is adapted to determine whether a pressure in the evaporator (26) lies below a specified minimum pressure and/or above a specified maximum pressure.

22. The centrifuge (10) according to claim 21,
wherein at least one of
the centrifuge motor (18),
an electrical supply line (74, 82) to a component which is not explosion-proof nor designed to absorb less than 20 W of electrical power,
a switch (76, 86) in an electrical supply line to a component which is not explosion-proof nor designed to absorb less than 20 W of electrical power, and
a control unit (58) of the centrifuge (10)
is arranged in a crash area of the centrifuge (10).

23. The centrifuge (10) according to claim 21, wherein
i) a solenoid valve (38) is arranged in front of an inlet of the evaporator (26), wherein the solenoid valve (38) is preferentially arranged in front of a pressure relief element (32) and/or
k) a non-return valve (40) is arranged after an outlet (42) of the evaporator (26) and/or
l) at least one of a main electrical switch (64), a fan (54), a pressure monitoring control (48) and a pressure monitoring sensor (44) is designed to be explosion-proof and/or to absorb less than 20 W electrical power.

24. The centrifuge (10) according to claim 21,
wherein the centrifuge (10) supplies a fan (54) with residual electrical energy present in the centrifuge (10) after a failure of an electrical power supply (62).

25. The centrifuge (10) according to claim 24,
further comprising a relay which is fed by an electrical power supply (62) and, in the event of the failure of the electrical power supply (62), connects at least one capacitor or accumulator to the fan (54).

26. The centrifuge (10) according to claim 25,
wherein the centrifuge (10) is configured to start a fan (54) of the centrifuge after switching on an electrical power supply (62) of the centrifuge (10).

27. The centrifuge (10) according to claim 25,
wherein the fan (54) is configured such that its flow passed over a temperature-control medium line (34) at least in some areas and/or through at least one cavity in the centrifuge (10) in such a manner that a resulting exhaust air is conveyed out of the housing (12) of the centrifuge (10).

28. The centrifuge according to claim 21,
further comprising a gas sensor arranged outside the temperature control,
wherein the centrifuge is prevented from starting when temperature-control medium is detected by the gas sensor.
